(19) United States
(12) Patent Application Publication
(10) Pub. No.: US 2013/0251025 A1
(43) Pub. Date: Sep. 26, 2013

(54) MEMORY BANDWIDTH REDUCTION DURING VIDEO CAPTURE

(71) Applicant: Roger Smith, Suwanee, GA (US)

(72) Inventor: Roger Smith, Suwanee, GA (US)

(73) Assignee: AMERICAN MEGATRENDS, INC., Norcross, GA (US)

(21) Appl. No.: 13/430,091

(22) Filed: Mar. 26, 2012

(51) Int. Cl. H04N 7/26; H04N 7/64

(52) U.S. Cl. 375/240.02; 375/240.01; 375/240.25; 375/240.27; 375/E07.026; 375/E07.027; 375/E07.126; 375/E07.279

(57) ABSTRACT

Certain aspects of the present disclosure are directed to a video processing module, including: a video capture module configured to capture a screen display; a compression module configured to compress the screen display to construct compressed data representing the screen display; and a memory module configured to store the compressed data. Certain aspects are directed to a computer-implementable method, including: reading compressed video data having a plurality of data units and representing a screen display out of a data storage, the data units including a line tag, an encoding tag, and a pixel value data unit; detecting a line tag from the compressed video data and extracting a line number from the line tag; receiving an expected line number from a counter; comparing the line number with the expected line number and determining a comparison result; and determining whether a fault exists based on the result.

### FIELD

The present disclosure is related to video compression and decompression in a computer network. More particularly, the present disclosure is related to compressing captured video data and decompressing and recovering the compressed video data.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Computer networks generally include a plurality of interconnected computer systems. Some computer networks utilize a local computer for communicating data to one or more remote computers that are connected to the local computer through the network. From the remote computer, users may control or view activity on a local computer over the network utilizing a hardware interface device connected to the local computer. For instance, utilizing the interface device, a user may view screen displays of video data on the remote computer that were generated by the local computer. Each screen display of video data may comprise thousands or millions of pixels, with each pixel representing a single point in a graphic image. Each point or pixel in a graphic image is represented by a predetermined number of bits based on the number of colors that are displayed on a graphics display. For example, 256 colors may be represented utilizing eight bits per pixel while a “true color” image may be generated utilizing 24 bits per pixel.

Typically, the local computer captures the video data representing screen displays output by a video graphics adapter and stores the captured video data in the memory of the local computer, before the video data are transmitted to the remote computers. The screen displays each may have millions of bits of video data and are captured and stored to the memory in real-time. Thus, this process may require significant memory bandwidth.

### SUMMARY

Certain aspects of the present disclosure are directed to a video processing module. In certain embodiments, the video processing module includes: a video capture module configured to capture a first screen display; a compression module configured to compress the first screen display to construct compressed data representing the first screen display; and a memory module configured to store the compressed data.

In certain embodiments, the compression module of the video processing module is configured to employ a run length encoding (RLE) engine, the RLE engine is configured to compress the first screen display using an RLE algorithm to obtain the compressed data.

In certain embodiments, the first screen display includes a plurality of lines each having a plurality of pixels, the compressed data include a plurality of line tags each indicating a respective one of the plurality of lines, and the compressed data include an encoding tag indicating the compressed pixels.

In certain embodiments, the video processing module further includes a decompression module that is configured to decompress the compressed data read from the memory module to construct decompressed data corresponding to the first screen display.

In certain embodiments, the video capture module of the video processing module is configured to capture a second screen display. The video processing module further includes an Adaptive Video Filter and Compression Module (AVFCM) configured to: receive the decompressed data from the decompression module; determine a difference between the decompressed data and data corresponding to the second screen display; and manipulate the data corresponding to second screen display based on the difference.

In certain embodiments, the AVFCM is further configured to transmit the manipulated data to a remote computer.

In certain embodiments, the decompression module is configured to construct the plurality of lines of the first screen display indicated by the plurality of line tags, and the compression module is configured to construct a plurality of pixels in a line based on the encoding tag.

In certain embodiments, the decompression module further includes a fault detection module configured to detect a fault of the compressed data read from the memory module; and a recovery module configured to remedy the fault.

In certain embodiments, the fault detection module is configured to detect that data representing a first pixel in one of the plurality of lines are missing from the compressed data. The recovery module is configured to construct a pixel of a predetermined color in place of the first pixel in the decompressed data.

In certain embodiments, the fault detection module is configured to detect that data representing a first line of the plurality of lines are missing from the compressed data. The recovery module is configured to construct a line of pixels each having a predetermined color in place of the first missing line in the decompressed data.

In certain embodiments, the fault detection module is configured to detect that data representing an abundant pixel in one of the plurality of lines exist in the compressed data. The recovery module is configured to discard the abundant pixel in the decompressed data.

In certain embodiments, the encoding tag is an RLE tag that indicates a number of consecutive pixels that are identical to a previous pixel in the first screen display.

In certain embodiments, the video processing module further includes a decompression module that is configured to decompress the compressed data read from the memory module to construct decompressed data corresponding to the first screen display. The decompression module is configured to construct the plurality of lines indicated by the plurality of line tags. The decompression module is configured to construct a plurality of identical pixels in a line based on the RLE tag.

Certain aspects of the present disclosure are directed to a computer-implementable method. In certain embodiments, the method includes the steps of: reading compressed video data having a plurality of data units and representing a first screen display out of a data storage module, the data units including a line tag, an encoding tag, and a pixel value data unit; detecting a first line tag from the compressed video data and extracting a first line number from the first line tag; receiving an expected line number from a counter module; comparing the first line number with the expected line number and determining a comparison result; and determining whether a fault exists in the compressed video data based on the comparison result.

In certain embodiments, the method further includes: determining whether a first group of data units representing a first line of pixels of the first screen display are missing from the compressed data based on the comparison result; and in response to a determination that the first group of data units are missing, constructing the first screen display with a line of pixels each having a predetermined color in place of the first line of pixels.

In certain embodiments, the method further includes: constructing a first line of pixels of the first screen display identified by the first line number using a first group of data units adjacent to the first line tag in the compressed video data.

In certain embodiments, the encoding tag is a Run-Length Encoding (RLE) tag, and the first line of pixels are constructed in accordance with an RLE algorithm based on the RLE tag.

In certain embodiments, using the first group of data units includes: determining whether a first data unit in the first group of data unit is an encoding tag; and in response to a determination that the first data unit is an encoding tag, constructing a pixel in the first line of pixels using encoding information contained in the first data unit and a pixel value contained in a pixel value data unit of the first group data units.

In certain embodiments, using the first group of data units includes: determining whether a first data unit in the first group of data unit is a pixel value data unit; and in response to a determination that the first data unit is a pixel value data unit, constructing a pixel in the first line of pixels having a pixel value contained in the first data unit.

In certain embodiments, the method further includes: determining whether the first line of pixels contain a predetermined number of pixels; and in response to a determination that the number of pixels in the first line is smaller than the predetermined number, constructing a complementary number of pixels each having a predetermined color in the first line of pixels such that the first line of pixels contain the predetermined number of pixels.

In certain embodiments, the method further includes: determining whether the first line of pixels contain a predetermined number of pixels; and in response to a determination that the number of pixels in the first line is greater than the predetermined number, discarding a number of pixels in the first line of pixels such that the first line of pixels contain the predetermined number of pixels.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a computer architecture diagram showing aspects of a computer system utilized in certain embodiments of the present disclosure;

FIG. 2 is a computer architecture diagram illustrating aspects of a video processing module provided in certain embodiments of the present disclosure;

FIG. 3 is a schematic diagram illustrating components of a video processing module provided in certain embodiments of the present disclosure;

FIG. 4 illustrates two simplified screen displays captured by a video capture module in accordance with certain embodiments of the present disclosure;

FIG. 5A illustrates pixel values of a simplified screen display in accordance with certain embodiments of the present disclosure;

FIG. 5B illustrates the compressed data representing the pixel values of a part of the screen display in FIG. 5A constructed by a compression module in accordance with certain embodiments of the present disclosure; and

FIG. 6 is a flowchart illustrating a process executed by a decompression module in accordance with certain embodiments of the present disclosure.

### DETAILED DESCRIPTION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

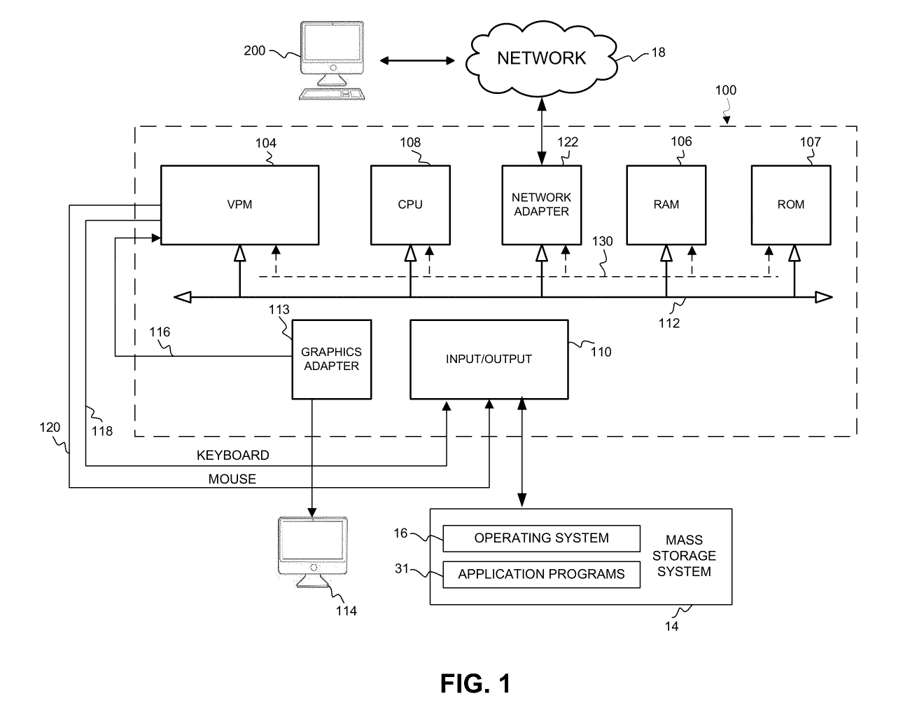

FIG. 1 and the following discussion are intended to provide a brief, general description of a suitable computing environment in which certain embodiments of the present disclosure can be implemented. While the present disclosure will be described in the general context of program modules that execute in conjunction with an application program that runs on an operating system on a computer system, those skilled in the art will recognize that certain embodiments may also be implemented in combination with other program modules.

Generally, program modules include routines, programs, components, data structures, and other types of structures that perform particular tasks or implement particular abstract data types. Moreover, those skilled in the art will appreciate that certain embodiments may be practiced with other computer system configurations, including hand-held devices, multiprocessor systems, microprocessor-based or programmable consumer electronics, minicomputers, mainframe computers, and the like. Certain embodiments may also be practiced in distributed computing environments where tasks are performed by remote processing devices that are linked through a communications network. In a distributed computing environment, program modules may be located in both local and remote memory storage devices.

Turning now to FIG. 1, an illustrative computer architecture for practicing the various embodiments of the present disclosure will now be described. In particular, a computer 100 is provided that is operative to compress and transmit its video display to a remote computer 200. The compressed data may be decompressed and displayed at the remote computer. The computer 100 is also operative to receive input remotely from the remote computer in the form of keyboard or mouse input. In this manner, the computer 100 may be controlled remotely. In order to provide this functionality, the computer 100 includes a baseboard, or “motherboard”, which is a printed circuit board to which a multitude of components or devices may be connected by way of a system bus 112 or other electrical communication path. In one illustrative embodiment, these components include, without limitation, a Video Processing Module (VPM) 104, a central processing unit (“CPU”) 108, a network adapter 122, a system memory and an input/output module 110. The computer 100 can include other components that are not explicitly shown in FIG. 1.

The system bus 112 utilized by the computer 100 provides a two-way communication path for all components connected to the system bus 112. The component that initiates a communication is referred to as a “master” component and the component to which the initial communication is sent is referred to as a “slave” component. A master component therefore issues an initial command to or requests information from a slave component. Each slave component is addressed, and thus communicatively accessible to the master component, using a particular slave address. Both master components and slave components are operable to transmit and receive communications over the system bus 112. Buses and the associated functionality of master-slave communications are well-known to those skilled in the art, and therefore not discussed in further detail herein.

The VPM 104 can include or be connected with a redirection controller that allows a user to control the keyboard and mouse functions of the local computer 100 from the remote computer 200 over the network 18. In certain embodiments, the VPM 104 may also be utilized to provide the video display shown on the local computer 100 to the remote computer 200. In particular, in accordance with illustrative embodiments of the present disclosure, the VPM 104 communicates compressed video data generated on the local computer 100 to the remote computer 200. To accomplish the above-noted and other functions, the VPM 104 is communicatively connected to one or more components either directly or by way of a management bus 130. In particular, the VPM 104 is connected to video out port 116 of the graphics adapter 113, as well as a keyboard input port and a mouse input port of the input/output module 110, via the communications lines 118 and 120, respectively. It will be appreciated that the keyboard port and mouse port may include universal serial bus (“USB”) ports and/or PS/2 ports. It should be appreciated that the VPM 104 may receive keyboard and mouse commands from the computer 200 via the network 18. When received, the VPM 104 is operative to pass the commands through to the input/output controller 110 so that the commands appear to the computer 100 to have been made utilizing local keyboard and mouse devices.

The network adapter 122 is communicatively connected to the management bus 130. The management bus 130 is used by the VPM 104 to communicate compressed video data to the remote computer 200 over the network adapter 122. Like the system bus 112, the component that initiates communication on a bus is referred to a master and the component to which the communication is sent is referred to a slave. As such, the VPM 104 functions as the master on the management bus 130 in most circumstances, but may also function as a slave in other circumstances. Each of the various components communicatively connected to the VPM 104 by way of the management bus is addressed using a slave address. In one embodiment, the management bus 130 may be an I²C® bus, which is manufactured by Phillips Semiconductors® and described in detail in the I²C® bus Specification, version 2.1 (January 2000). The VPM 104 also includes compression program code which may be an executable program module containing program code for filtering and compressing video data for communication over the network 18 to the remote computer 200. It should be appreciated that the VPM 104 may be configured with its own network adapter for communicating with the remote computer 200 directly over the network 18.

The system memory in the computer 100 may include a random access memory (“RAM”) 106 and a read-only memory (“ROM”) 107. The ROM 107 may store a basic input/output system that includes program code containing the basic routines that help to transfer information between elements within the computer 100. The network adapter 122 may be capable of connecting the local computer 100 to the computer 200 via the network 18. Connections which may be made by the network adapter 122 may include local area network (“LAN”) or wide area network (“WAN”) connections. LAN and WAN networking environments are commonplace in offices, enterprise-wide computer networks, intranets, and the Internet.

The CPU 108 is a standard central processor that performs arithmetic and logical operations necessary for the operation of the computer system 100. CPUs are well-known in the art, and therefore not described in further detail herein. The input/output module 110 is used as a communication medium between any number and type of peripheral devices and the system bus 112. Communications destined for the CPU 108, the VPM 104 or any other component coupled to the system bus 112 and issued by a peripheral device must therefore pass through the input/output module 110 to the system bus 112 and then to the necessary component.

As shown in FIG. 1, the input/output module 110 is connected a mass storage device 14 for storing an operating system 16 and application programs 31. The operating system 16 comprises a set of programs that control operations of the local computer 100 and allocation of resources. The set of programs, inclusive of certain utility programs, also provide a graphical user interface to the user. An application program is software that runs on top of the operating system software and uses computer resources made available through the operating system to perform application specific tasks desired by the user.

The mass storage device 14 and its associated computer-readable media, provide non-volatile storage for the local computer 100. Although the description of computer-readable media contained herein refers to a mass storage device, such as a hard disk or CD-ROM drive, it should be appreciated by those skilled in the art that computer-readable media can be any available media that can be accessed by the local computer 100. By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

A graphics adapter 113 is also utilized that enables the display of video data (i.e., text and/or graphics) on a display unit 114. It will be appreciated that the video graphics adapter may process analog signals (i.e., VGA) or digital signals (i.e., DVI) for display on a compatible display unit. The video graphics adapter 114 includes a video buffer for temporarily storing one or more lines of video data to be displayed on the display unit 114.

It will be appreciated that the computer 200 described briefly above with respect to FIG. 1 may be a general purpose computer including some or all of the conventional computing components described above relative to the local computer 100. In addition, the computer 200 may further include a hardware keyboard and mouse connected to an input/output module for controlling keyboard and mouse functions of the computer 100 utilizing the VPM 104. It should also be appreciated that the computers 100 and 200 may also include other types of computing devices, including hand-held computers, embedded computer systems, personal digital assistants, and other types of computing devices known to those skilled in the art.

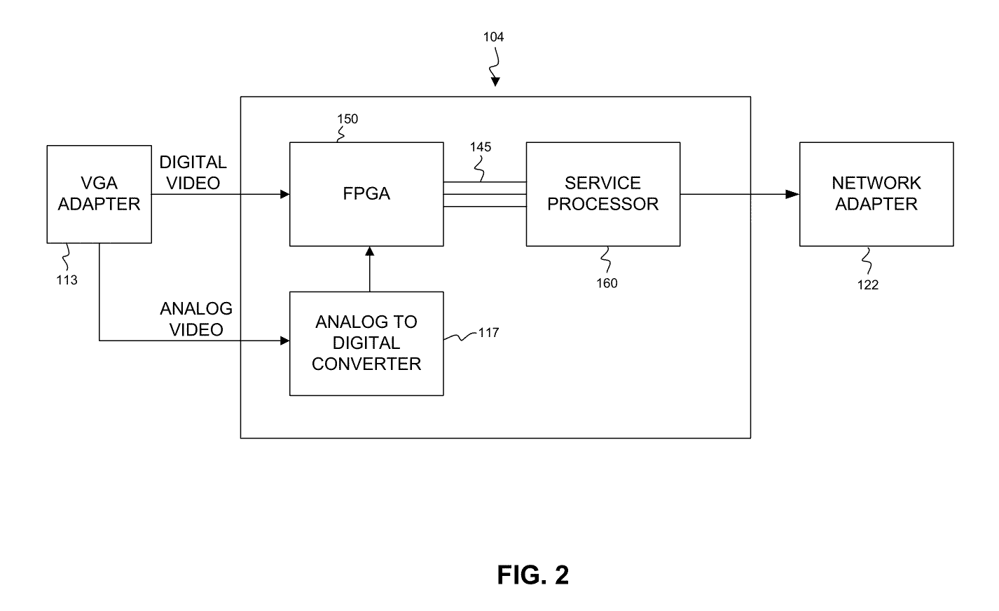

Turning now to FIG. 2, an illustrative hardware architecture of the VPM 104 will now be described. The VPM 104 is communicatively connected to the graphics adapter 113 for receiving, filtering, and/or compressing video data. The video data can be then communicated to the remote computer 200 through the network adapter 122. As shown in FIG. 2, the VPM 104 may be connected to the graphics adapter 113 through a digital video or analog video connection. Where an analog video connection is utilized, the redirection controller 104 may utilize an analog to digital converter 117 to convert the received analog display screens into a digital format.

In accordance with certain embodiments, the components of the VPM 104 may be incorporated into a firmware card, such as a PCI card, which is “plugged-in” to the motherboard of the computer 100. These components may include a field-programmable gate array (“FPGA”) 150 and a service processor 160. The FPGA 150 communicates with the service processor 160 over parallel bus 145. The service processor 160 is a microcontroller that instructs the FPGA 150 to capture screen displays of video data from the video graphics adapter 113, process the captured data, and compress the processed video data in accordance with program instructions contained in the compression program code 132. A screen display generally refers to video data that represent, for example, a screen displayed on a computer monitor. Once the processed video data has been compressed, the FPGA 150 generates and sends an interrupt signal to the service processor 160. The service processor 160 then sends the compressed video data to the remote computer 200 via the network adapter 122 or to the memory module. It will be appreciated that the FPGA 150 and the service processor 160 may be application specific circuits (“ASICs”) designed for performing the aforementioned tasks. ASICs are well known to those skilled in the art. Those skilled in the art will further appreciate that the VPM 104 may also be incorporated as an external hardware device. The external device may include a video port for connection to a video graphics adapter, keyboard and mouse ports, and a network port (e.g., a network interface card) for connection to a computer network.

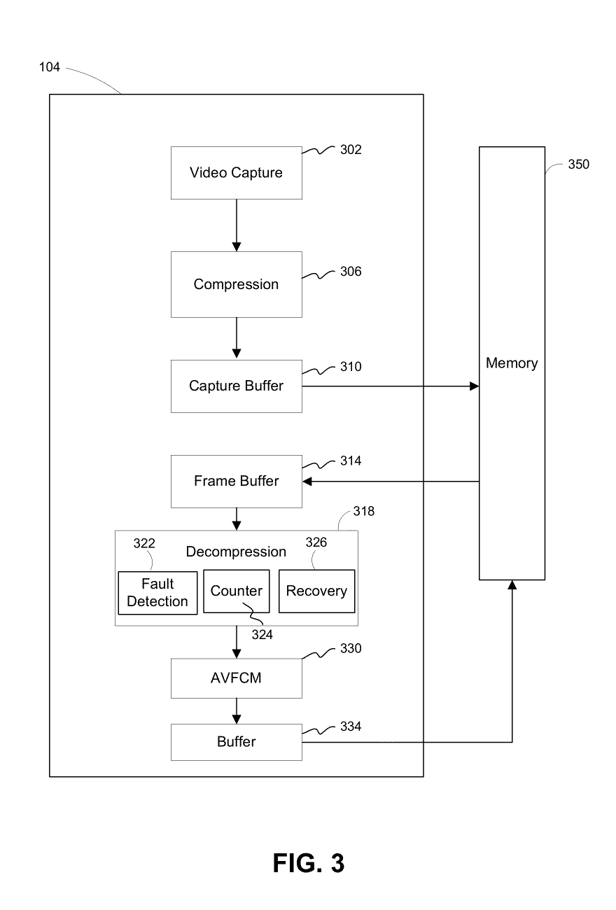

FIG. 3 schematically shows functional and/or physical modules of the VPM in accordance with certain embodiments of the present disclosure. The VPM 104 module can include a video capture module (VCM) 302, a compression module 306, buffers 310, 314, 334, a decompression module 318, which may include a fault detection module 322, a counter 324, and a recovery module 326, as well as an adaptive video filter and compression module (AVFCM) 330. The AVFCM 330 can utilize, for example, Advanced Adaptive Video Compression Algorithm (AAVICA). Some or all the modules discussed can be implemented by one physical module. Each of the modules discussed can also be implemented in a separate physical module.

As discussed above, the VCM 302 can capture video data representing screen displays. The video data can be output from a video graphics adapter for displaying at a computer monitor. For example, the VCM 302 can capture a set of video data corresponding to the pixels of a screen display. In addition, the VCM 302 can capture more than one screen display or consecutive screen displays. The VPM 104 can communicate with a memory module 350 such as storing video data to and reading video data from the memory module 350.

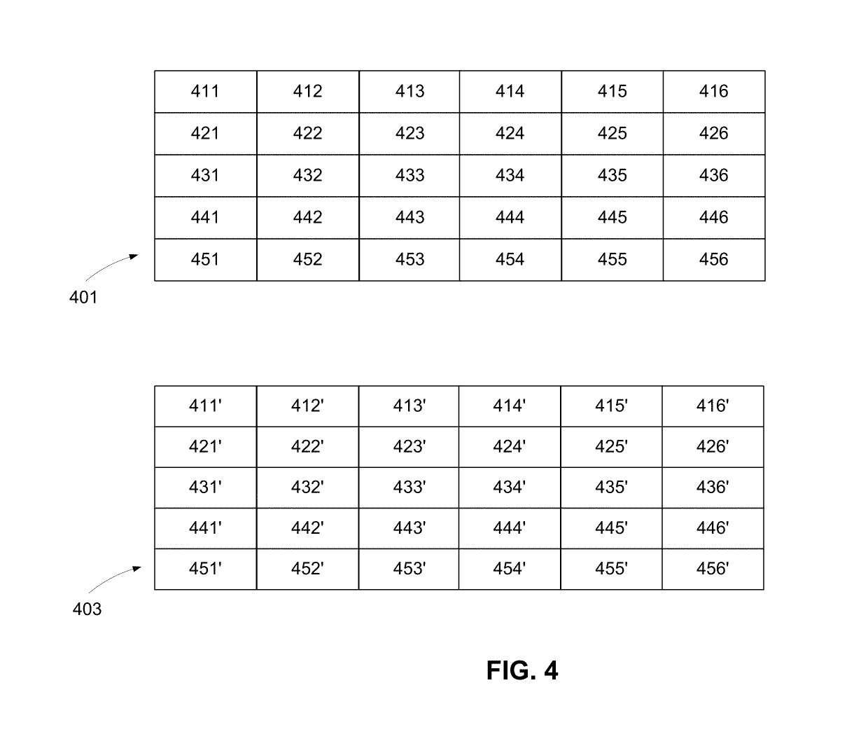

Turning now to FIG. 4, two screen displays 401, 403 that are captured by the VCM 302 are shown. The two screen displays shown are simplified examples for illustration only, as each screen display only has five lines and six columns. In reality, each screen display captured by VCM 302 can have thousands of lines and thousands of columns. In this example, the first screen display 401 represents pixels from a previous screen display. The second screen 403 represents pixels of a current screen display. It should be appreciated that the pixels in each of the screen displays correspond to one another. For instance, the pixel 423 in the third column of the second line in the first screen display 401 corresponds to the pixel 423′ in the third column of the second line in the second screen display 403. It should be appreciated that each of the pixels has an associated value that describes the color and intensity of the pixel. For instance, in certain embodiments, a 15-bit value can be utilized to represent a pixel. In certain embodiments, a 24-bit value can be utilized to represent a pixel.

In certain embodiments, the VCM 302 can capture two or more screen displays and stores the video data to the memory module 350. The AVFCM 330 can include a filter, an encoder, and a compressor. The AVFCM 330 can read out the captured video data from the memory module 350 for further processing. In certain embodiments, the AVFCM 330 can read out two screen displays, e.g. the previous screen display 401 and the current screen display 403 as illustrated in FIG. 4 and discussed above, from the memory module 350. The AVFCM 330 can compare the corresponding pixels of the previous screen display 401 and the current screen display 403, and determines whether the values of the pixels at a specific location in the current screen display 403 and the previous screen display 401 are different. In certain embodiments, if the values are the same or the difference is within a threshold, the AVFCM 330 can manipulate the current screen display 403 such as changing the value of the specific pixel in the current screen 403 display to a different value, e.g., 0. The threshold can be dynamic and based on the values of the surrounding pixels and/or based on the level of distortion tolerance (e.g. lossy or lossless). In certain embodiments, the AVFCM or other modules of the local computer 100 to the remote computer 200.

After the pixels in the current screen display 403 have been processed as discussed above by the AVFCM 330, in certain embodiments, the processed current screen display can be further compressed by the AVFCM 330. The processed current screen display can be compressed to a higher degree comparing to the original current screen display 403 that is not processed, because the values of the pixels that are not considered changed, comparing to the previous screen display, are modified to allow a higher degree of compression. For example, if a line of pixels in the current screen display 403 respectively have the same values as those of the corresponding pixels in the previous screen display 401, that line of pixels can be all changed to black color. A line of black pixels can be compressed to a higher degree by using a typical compression and/or encoding algorithm such as Run-length Encoding (RLE).

Referring to FIG. 3, in certain embodiments, the screen displays captured by the VCM 302 can be initially processed and compressed before being saved to the memory module 350. In certain embodiments, other data storage module can be used in place of the memory module 350. This can reduce memory bandwidth during video capture and compression. For example, the computer system 100 can employ the compression module 306 to compress the captured screen displays in real time and then stores the compressed screen displays to the memory module 350.

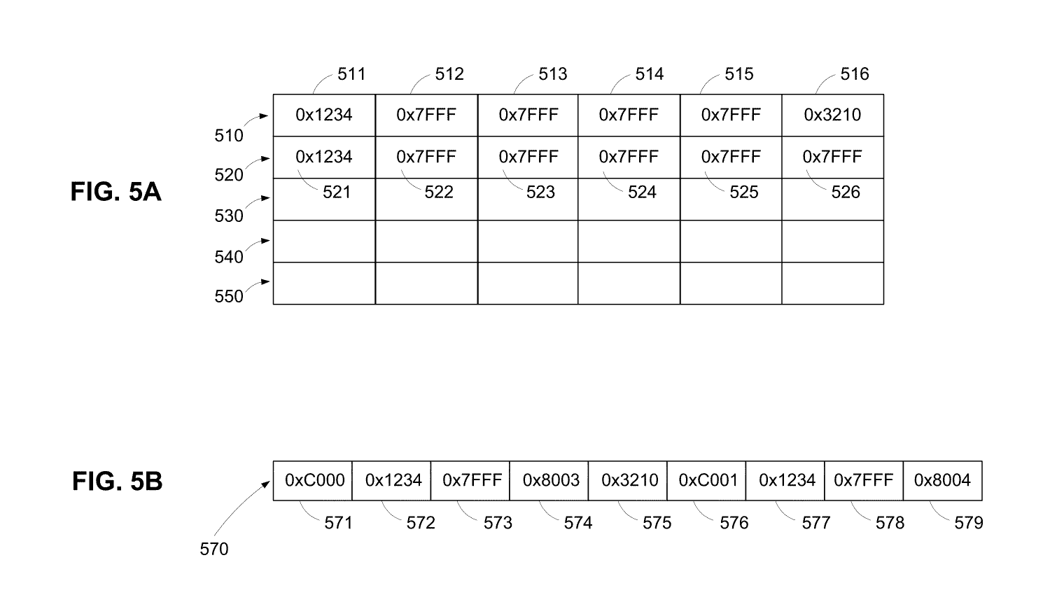

In certain embodiments, the compression module 306 can employ the RLE and uses an RLE engine. Referring to FIG. 5A, a screen display 501 that is captured by the capture module and has not been processed by the compression module 306 is shown. In this simplified example, the screen display 501 corresponds to the screen displays 401, 403 shown in FIG. 4 and has five lines and six columns.

In certain embodiments, the compression module 306 reads the pixel data from the VCM 302 and processes the pixel data to construct compressed pixel data. In certain embodiments, the screen displays can be temporarily stored in a buffer (not shown) after being captured. The compression module accordingly can read the pixel data from the buffer.

In certain embodiments, each pixel can be represented by a 15-bit value. The compression module 306 can process the received pixel data and construct the compressed data using data units each having 16 bits, of which the first two bits are the most significant bits (MSB). In certain embodiments, the compressed data can include line tags, encoding tags, and pixel value data units. The encoding tags are used to show pixel data are compressed and/or what pixel data are compressed. When RLE is used for compression, encoding tags can be also referred to as RLE tags.

The line tag can be a 16-bit data unit. In this example, the MSB of the line tag can be assigned “11” in binary form, which can be accordingly used to distinguish a line tag from the other data units. For example, when reading pixels in a line of the screen display 501, the compression module 306 generates a line tag to identify that line. The first two bits of the line tag are “11”. The rest 14 bits of the line tag are used to record the line number. For example, the compression module 306 can assign line number 0 to the first line 510 of the screen display 501. Accordingly, the line tag for the first line 510 is “0xC000” in hexadecimal form. Likewise, the compression module 306 can assign line number 1 to the second line of the screen display 501. Accordingly, the line tag for the second line is “0xC001”. FIG. 5B schematically shows the compressed data 510 constructed by the compression module 306 for the first two lines 510, 520 of the screen display 501. The first data unit 571 is a line tag “0xC000” identifying the first line 510 of the screen display 501.

The compression module 306 parses the pixel values in a screen display and constructs the compressed data based on the pixel values and the compression algorithm employed. In this example, the compression module 306 can also use a 16-bit data unit to represent the value of a pixel. The first bit of a pixel value data unit is “0”, which can be used to distinguish that pixel unit from a line tag, as discussed above, and an RLE tag, as will be described below. In this specific example, an RLE algorithm is used. The compression module 306 determines whether two or more consecutive pixels have identical values. For example, in the example screen display 501 shown in FIG. 5A, the second, third, fourth, and fifth pixel in the first line 510 have the same value (i.e. “0x7FFF”). In certain embodiments, when processing the pixel values in the first line 510, the compression module 306 initially reads the value of the first pixel 511 (i.e. “0X1234”). The compression module 306 adds a data unit 572 of “0X1234” to the constructed compressed data 570 after the line tag 571. Then, the compression module 306 reads the value of the second pixel 512 and determines whether the value of the second pixel 512 (i.e. “0x7FFF”) is the same as the value of the first pixel 511. Because the value of the second pixel 512 is not the same as that of the first pixel 511, the compression module 306 adds a data unit 573 of “0x7FFF” to the compressed data 570. The compression module 306 reads the value of the third pixel 513 and determines whether the value of the third pixel 513 is the same as the second pixel. In this example, the value of the third pixel 513 (i.e. “0x7FFF”) is the same as that of the second pixel 12. Thus, the compression module 306 continues to read the value of the fourth pixel 514 and determines whether the value of the fourth pixel is the same as the value of the third pixel 513, and so on. In this example, the compression module determines that the values of the second, third, fourth, and fifth pixel 512, 513, 514, 515 are the same. The compression module then determines that the value of the sixth pixel 516 is different from that of the fifth pixel 515. Accordingly, the compression module 306 constructs an RLE tag.

Typically, an RLE tag that indicates a number of consecutive pixels that are identical to a previous pixel in the compressed data. In this example, the RLE tag uses a 16-bit data unit as well. The MSB of the RLE tag can be assigned “10” in binary form. The rest 14 bits of the RLE tag are used to record the RLE count, i.e. the number of the additional consecutive pixels having the same value as that of the initial pixel. In other words, the RLE count is the number of the consecutive identical pixels minus one. In this example, the values of the second, third, fourth, and fifth pixel 512, 513, 514, 515 are the same and, thus, the RLE count is 3. Accordingly, the RLE tag 574 is “0X8003” in hexadecimal form. The compression module adds the RLE tag 574 to the compressed data 570, following the data unit 573 representing the second pixel 512. Then, the compression module adds a data unit 575 (i.e. “0X3210”) representing the sixth pixel 516, the last pixel in the first line 510, to the constructed compressed data 570.

In the above example, when constructing the compressed data 570 representing a line in the screen display 501, the compression module 306 first constructs a line tag identifying that line and then appends data units representing the pixel values of that line after the line tag. The data units can include RLE tags indicating the number of additional pixels having the same value as that of the pixel right before the RLE tags. Of course, in certain embodiments, the compressed data, including its format and the locations of the tags, can be constructed differently.

The above example shows how the compression module 306 can process the first line 510 of the screen display 501 and construct the compressed data 570 for the first line 510. The compression module 306 can similarly process lines two to five 520, 530, 540, 550 and constructs compressed data for each line. For example, the compressed data for the second line 520 has a line tag 576 of “0xC001”, which is followed by two data units 577, 578 of “0X1234” and “0x7FFF”, which are followed by an RLE tag 579 of “0X8004”. Note that the second line has five identical consecutive pixels 522-526 each having a value of “0x7FFF”.

Again, as shown in FIG. 5B, the compressed data for a line typically start with a line tag identifying the line number and have data units representing the pixel values in that line following the line tag. When a line has identical pixels, the data units include one or more RLE tags.

The compression module 306 outputs the above constructed compressed data 570, which can be further stored in the memory module 350. Similarly, some or all of the screens displays captured by the VCM 302 can be processed by the compression module 306 and the corresponding compressed data can be stored in the memory module 350.

In certain embodiments, the compression module 306 stores the compressed data into one or more capture buffers 310 in real-time. The capture buffers 310 typically are First-In-First-Out (FIFO) buffers of predetermined sizes. The compressed data 570 are subsequently sent from the capture buffers 310 to the memory module 350.

In certain embodiments, before the compressed data 570 for the two screen displays 401, 403 can be processed by the AVFCM 330, the compressed data 570 are decompressed by a decompression module 318. The compressed data 570 for the screen displays 401, 403 can be sent from the memory module 350 to one or more frame buffers 314. In certain embodiments, one frame buffer 314 is used to temporarily store compressed data for the previous screen display 401, and another frame buffer 314 is used to temporarily store compressed data for the current screen display 403. The decompression module 318 reads the compressed data 570 out of a frame buffer 314.

In certain embodiments, the decompression module 318 reads out a data unit for a screen display 401, 403 from the frame buffer 314 and then process that data unit, before reading out another data unit from the frame buffer 314. In certain embodiments, the decompression module 318 can read out more than one data units for the screen display 401, 403 and, then, processes those data units. When decompressing the compressed data 570 as shown in FIG. 5B representing the screen display 501, the decompression module 318 first encounters a line tag 571. The decompression module can determines that a data unit is the line tag based on the MSB of that data unit. In other words, if the MSB are “11” in binary form, the decompression module determines that this data unit is a line tag. The decompression module can determine the line number from the line tag and determines whether the line number is the expected value. In this specific example, the decompression module 318 expects that the line number for the first line tag 571 encountered is 0 and that the line number in a subsequent line tag 576 is the line number in the previous line tag plus 1. If the line number determined from a line tag 571, 576 is not the expected value, the decompression module 318 can flag an error. After encountering a line tag, the decompression module 318 decompresses the data units 572-575, 577-579 following that line tag 571, 576 to construct the pixel values for that line 510, 520 of the screen display 501.

For each data unit, the decompression module 318 determines whether that data unit contains a line tag, raw pixel data, or an RLE tag. The decompression module 318 can determine a line tag as discussed above. If the MSB of a data unit is “10” in binary form, the decompression module 318 determines the data unit contains an RLE tag. If the MSB of the data unit start with “0” in binary form, the decompression module 318 determines the data unit contains raw pixel data. When the decompression module 318 encounters a data unit having raw pixel data, the decompression module 318 adds the raw pixel data to the decompressed data for that line. When the decompression module 318 encounters a RLE tag, the decompression module 318 adds, to the decompressed data, additional number of pixels, as indicated by the RLE tag, that are identical to the pixel represented by the previous data unit having raw pixel that the decompression module has encountered.

For example, the decompression module can decompress the compressed data 570 shown in FIG. 5B to construct the decompressed data of the screen display of 501 shown in FIG. 5A. After reading the first line tag 571 having value of “0xC000”, which indicates the line number 0, the decompression module 318 encounters the data unit 572 having value of “0x1234”. The decompression module 318 accordingly constructs the decompressed data for the first line of that screen display 501, with a first pixel 511 having pixel value of “0X1234”. Continuing processing the compressed data for that line 510, the decompression module 318 encounters a data unit 573 having value of “0x7FFF”, and accordingly adds a second pixel 512 having value of “0x7FFF” to that line 510 in the decompressed data. Then, the decompression module 318 encounters the RLE tag 574 having value “0X8003”. The decompression module accordingly adds three identical pixels 513-515 having value of the previous pixel 512, i.e., “0x7FFF”, to that line. The decompression module next encounters a data unit 575 having value of “0X3210”, and adds the sixth pixel 516 having a value of “0X3210” to that line 510 in the decompressed data. Therefore, the decompression module 318 has constructed the decompressed data for the first line of the screen display 501.

In certain embodiments, the decompression module 318 can use the fault detection module 322 detect a fault, such as missing data of corrupted data, of the compressed data read from the memory module. In certain embodiments, based on the configuration of the computer system 100, the decompression module 318 typically has the information of the resolution of the screen display, e.g., the number of total pixels in a line and the total number of lines in a screen display. When the decompression module 318 has encountered a new tag read from the frame buffer 314, the decompression module 318 can determine the number of pixels in the previous line that have just been constructed and determines whether the newly encountered line tag is at an expected location. In other words, the decompression module 318 typically expects that the number of the pixels in a line is in accordance with the resolution information that the decompression module 318 has. In certain embodiments, the decompression module 318 can employ a fault detection module 322 to implement the above functions.

When the number of pixels in a line is not in accordance with the information that the decompression module 318 has, the decompression module 318 can flag an error and initiate a recovery process. The decompressed data for a line may have more or less pixels than the number of pixels expected.

When decompressing the compressed data 570 shown in FIG. 5B, if after reading the RLE tag 574, instead of reading the data unit 575 having raw pixel data of “0X3210”, the decompression module 318 encounters another line tag (e.g., “0xC001” for the second line), Then the decompression module, having the information that each line of the screen should have six pixels, determines that the just constructed first line in the decompressed data is not in accordance with the information, because that line only has five pixels. The decompression module 318 can flag an error, indicating, e.g., some data are missing from the first line.

When the decompression module 318 determines that the number of pixels in a line is less than the expected number of pixels based on the information held by the decompression module 318, the decompression module 318 can invoke one or more recovery processes. In certain embodiments, the decompression module adds the missing number of pixels with predetermined values to that line in the decompressed data for the screen display. In other words, the decompression module replaces the missing pixels with the pixels with predetermined values. For example, the added pixels can all have the value of 0, i.e., be black pixels.

When the decompression module 318 determines that the number of pixels in a line is more than the expected number of pixels based on the information held by the decompression module 318, the decompression module 318 can invoke one or more recovery processes. In other words, the compressed data in that line have abundant pixels and can be considered as corrupted. In certain embodiments, the decompression module 318 can discard, or remove from the decompressed data for that line, the pixels that exceed the expected number of pixels. In certain embodiments, the decompression module 318 can employ a recovery module 326 to implement the above discussed recovery functions. The recovery module 326 can remedy the fault detected by the fault detection module.

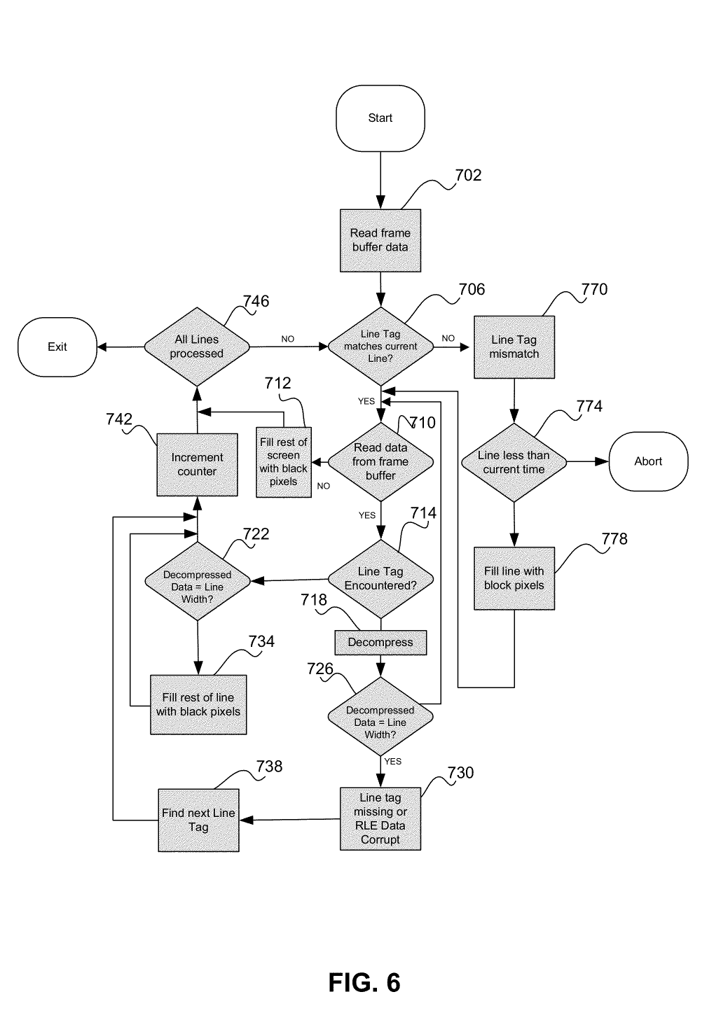

FIG. 6 is a flowchart illustrating the decompression process in accordance with certain embodiments of the present disclosure. For example, control of the decompression module 318 or other modules of the computer system 100 can execute the process. After starting, control enters procedure 702. In this example, at procedure 702, control reads compressed data 570 from the frame buffer 314 and detects a line tag 571, 576 in the compressed data 570 read. After detecting a line tag, control enters procedure 706. At procedure 706, control extracts the line number from the line tag 571, 576 and determines whether the line number in the line tag 571, 576 matches the expected line number. In this specific example, at the beginning of decompressing process, the initial expected line number for the first line tag 571 is 0. After, the control may employ the counter 324 that is incremented each time after the compressed data for a line are decompressed to indicate the currently expected line number. For example, after control reads the second line tag 576, the counter 324 is incremented from 0 to 1, indicating that the line number extracted from the currently encountered line tag (i.e., the second line tag 576) is expected to have a line number 1. At procedure 706, if control determines that the line number extracted from the current line tag 571, 576 matches the currently expected line number, control enters procedure 710; if not, control enters procedure 770.

At procedure 710, control attempts to read the next data unit from the frame buffer 314. If control reads another data unit, control enters procedure 714. If not, control enters procedure 712. At procedure 714, control determines whether the data unit just read is another line tag. If the data unit is not a line tag, control enters procedure 718. If the data unit is another line tag, control enters procedure 722.

At procedure 712, control determines that compressed data are missing data representing the rest of the screen display 501. Control can add to the decompressed data pixels of predetermined values, such as black pixels, for the rest of the screen display 501. In other words, control can fill the missing pixels with black pixels. Control then increments the counter 324 to set the currently expected line number to a number greater than the expected total line number of the screen display 501.

At procedure 770, control determines that the line number extracted from the line tag just read does not match the line number expected by the control. Control then enters procedure 774. At procedure 774, control determines whether the line number extracted from the line tag is less than the currently expected line number. If the line number is less than the currently expected line number, control aborts the decompressing process and can flag an error. If the line member is greater than the currently expected line number, control enters procedure 778. At procedure 778, control can interpret that the difference between the expected line number and the extracted line number indicates certain lines are missing from the compressed data. For example, if after constructing line 510 of the screen display 501, control encounters a line tag having line number 2 instead of 1, control can determine that data representing line 520 are missing from the compressed data 570. Control can invoke one or more recovery process to recover the missing line(s). In certain embodiments, control can fill the missing line(s) with line(s) having predetermined pixels, such as black pixels. In other words, control can add the missing number of black pixel line(s) to the decompressed data of the screen display 501. Then control enters procedure 710.

At procedure 718, control processes the data unit just read and adds the pixel values to the decompressed data for the current line of the screen display 501. The data unit being processed can be a raw pixel data unit or an encoding tag such as an RLE tag, and control constructs the decompressed data accordingly as discussed above.

At procedure 726, control determines whether the number of pixels that have been constructed for the current line is greater than the expected line width in accordance with the information held by the control. If the number of pixels is not greater than the expected line width, control returns to procedure 710. If the number of pixels is greater than the expected line width, control enters procedure 730.

At procedure 730, control determines that a line tag is missing or the RLE data are corrupted, and then discard the data unit just read. The control then enters procedure 738. At procedure 738, control reads another data unit from the frame buffer 314 and determines whether the data unit is a line tag. If the data unit is not a line tag, control discards that data unit and reads another data unit from the frame buffer 314. Control repeats this process until another line tag is encountered or that control can read o more data from the frame buffer 314 for the screen display 501, after which control enters procedure 742.

At procedure 722, control determines whether the number of pixels in the line constructed before encountering the line tag is less than the expected line width. If the number of pixels is less than the expected line width, control enters procedure 734. If not, control enters procedure 742.

At procedure 734, control determines that certain pixels are missing from the line that was being constructed before control encountered the line tag. In certain embodiments, Control can fill the rest of that line with pixels of predetermined color. For example, control can add to that line of the screen display 501 with additional number of black pixels, where the additional number is the difference between the expected line width and the actual number of pixels constructed in that line. Then, control enters procedure 742.

At procedure 742, control increments the counter 324 by one to indicate the line number of the new line that is to be constructed. Then control enters procedure 746. At procedure 746, control determines whether all the lines in the screen display 501 have been constructed. For example, control can determine whether the currently expected line number is greater than the total line number in accordance with the information held by control. If control determines that of the lines in the screen have been constructed, control exits the decompressed process. Otherwise, control returns to procedure 706.

It will be appreciated that embodiments of the present disclosure provide methods, systems, apparatus, and computer-readable medium for filtering, encoding, and compressing video data. Although the embodiments have been described in language specific to computer structural features, methodological acts and by computer readable media, it is to be understood that the present disclosure is not necessarily limited to the specific structures, acts or media described. The specific structural features, acts and mediums are disclosed as exemplary embodiments.

The various embodiments described above are provided by way of illustration only and should not be construed to limit the invention. Those skilled in the art will readily recognize various modifications and changes that may be made to the present disclosure without following the example embodiments and applications illustrated and described herein, and without departing from the true spirit and scope of the present disclosure.

What is claimed is:

1. A video processing module, comprising:
a video capture module configured to capture a first screen display;
a compression module configured to compress the first screen display to construct compressed data representing the first screen display; and
a memory module configured to store the compressed data.

2. The video processing module of claim 1, wherein the compression module is configured to employ a run length encoding (RLE) engine, the RLE engine is configured to compress the first screen display using an RLE algorithm to obtain the compressed data.

3. The video processing module of claim 1, wherein the first screen display includes a plurality of lines each having a plurality of pixels, wherein the compressed data include a plurality of line tags each indicating a respective one of the plurality of lines, and wherein the compressed data include an encoding tag indicating the compressed pixels.

4. The video processing module of claim 3, further comprising a decompression module that is configured to decompress the compressed data read from the memory module to construct decompressed data corresponding to the first screen display.

5. The video processing module of claim 4, wherein the video capture module is configured to capture a second screen display;
wherein the video processing module further comprises an Adaptive Video Filter and Compression Module (AVFCM) configured to
receive the decompressed data from the decompression module;
determine a difference between the decompressed data and data corresponding to the second screen display; and
manipulate the data corresponding to second screen display based on the difference.

6. The video processing module of claim 5, wherein the AVFCM is further configured to transmit the manipulated data to a remote computer.

7. The video processing module of claim 4, wherein the decompression module is configured to construct the plurality of lines of the first screen display indicated by the plurality of line tags, wherein the compression module is configured to construct a plurality of pixels in a line based on the encoding tag.

8. The video processing module of claim 7, wherein the decompression module further comprises
a fault detection module configured to detect a fault of the compressed data read from the memory module; and
a recovery module configured to remedy the fault.

9. The video processing module of claim 8, wherein the fault detection module is configured to detect that data representing a first pixel in one of the plurality of lines are missing from the compressed data, wherein the recovery module is configured to construct a pixel of a predetermined color in place of the first pixel in the decompressed data.

10. The video processing module of claim 8, wherein the fault detection module is configured to detect that data representing a first line of the plurality of lines are missing from the compressed data, wherein the recovery module is configured to construct a line of pixels each having a predetermined color in place of the first missing line in the decompressed data.

11. The video processing module of claim 8, wherein the fault detection module is configured to detect that data representing an abundant pixel in one of the plurality of lines exist in the compressed data, wherein the recovery module is configured to discard the abundant pixel in the decompressed data.

12. The video processing module of claim 3, wherein the encoding tag is an RLE tag that indicates a number of consecutive pixels that are identical to a previous pixel in the first screen display.

13. The video processing module of claim 12, further comprising a decompression module that is configured to decompress the compressed data read from the memory module to construct decompressed data corresponding to the first screen display, wherein the decompression module is configured to construct the plurality of lines indicated by the plurality of line tags, wherein the decompression module is configured to construct a plurality of identical pixels in a line based on the RLE tag.

14. A computer-implementable method, comprising the steps of:
reading compressed video data having a plurality of data units and representing a first screen display out of a data storage module, the data units including a line tag, an encoding tag, and a pixel value data unit;
detecting a first line tag from the compressed video data and extracting a first line number from the first line tag;
receiving an expected line number from a counter module;
comparing the first line number with the expected line number and determining a comparison result; and
determining whether a fault exists in the compressed video data based on the comparison result.

15. The computer implementable method of claim 14, further comprising:
determining whether a first group of data units representing a first line of pixels of the first screen display are missing from the compressed data based on the comparison result; and
in response to a determination that the first group of data units are missing, constructing the first screen display with a line of pixels each having a predetermined color in place of the first line of pixels.

16. The computer implementable method of claim 14, further comprising:
constructing a first line of pixels of the first screen display identified by the first line number using a first group of data units adjacent to the first line tag in the compressed video data.

17. The computer implementable method of claim 16, wherein the encoding tag is a Run-Length Encoding (RLE) tag, wherein the first line of pixels are constructed in accordance with an RLE algorithm based on the RLE tag.

18. The computer implementable method of claim 16, wherein using the first group of data units comprises:
determining whether a first data unit in the first group of data unit is an encoding tag; and
in response to a determination that the first data unit is an encoding tag, constructing a pixel in the first line of pixels using encoding information contained in the first data unit and a pixel value contained in a pixel value data unit of the first group data units.

19. The computer implementable method of claim 16, wherein using the first group of data units comprises:
determining whether a first data unit in the first group of data unit is a pixel value data unit; and
in response to a determination that the first data unit is a pixel value data unit, constructing a pixel in the first line of pixels having a pixel value contained in the first data unit.

20. The computer implementable method of claim 16, further comprising:
determining whether the first line of pixels contain a predetermined number of pixels; and
in response to a determination that the number of pixels in the first line is smaller than the predetermined number, constructing a complementary number of pixels each having a predetermined color in the first line of pixels such that the first line of pixels contain the predetermined number of pixels.

21. The computer implementable method of claim 16, further comprising:
determining whether the first line of pixels contain a predetermined number of pixels; and
in response to a determination that the number of pixels in the first line is greater than the predetermined number, discarding a number of pixels in the first line of pixels such that the first line of pixels contain the predetermined number of pixels.
